(19) United States
(12) Patent Application Publication
(10) Pub. No.: US 2007/0006757 A1
(43) Pub. Date: Jan. 11, 2007

(54) Inking device of printing press

(75) Inventor: Akehiro Kusaka, Noda-shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 11/474,470

(22) Filed: Jun. 26, 2006

(30) Foreign Application Priority Data
Jun. 28, 2005 (JP) 2005-187985

(51) Int. Cl. B41F 31/00

(52) U.S. Cl. 101/350.1

(57) ABSTRACT

An inking device of a printing press, including an ink ductor roller reciprocating between a receipt position, at which the ink ductor roller contacts an ink fountain roller to receive ink, and a transfer position, at which the ink ductor roller contacts an ink distribution roller or a first intermediate roller located downstream in an ink transfer direction to pass the ink on to the roller, comprises: a pair of split clamping holders supporting the ink ductor roller and supported swingably; and moving means, comprising a shaft, a sleeve, a bearing portion, a worm wheel, a worm shaft, and an operating shaft having a dial-equipped handle, for moving the pair of split clamping holders in the axial direction of the ink ductor roller.

### BACKGROUND OF THE INVENTION

1. Field of the Invention

This invention relates to an inking device of a printing press and, more particularly, to an inking device of a printing press preferred for rainbow printing.

2. Description of the Related Art

A rainbow printing press is disclosed, for example, in Japanese Patent Application Laid-Open No. 2001-310447. It is a rainbow printing press of a so-called double duct type, in which ink is flowed only on projections of each of upper and lower ink ductor rollers having the projections and depressions on their roller surfaces, and inks flowed on these projections are merged by an ink merger (distribution) roller to carry out rainbow printing.

Thus, lateral alignment between the upper and lower ink ductor rollers is important, and lateral alignment of the projections of the upper and lower ink ductor rollers with plate cylinders (plate surfaces) is also important.

In performing adjusting work for this purpose, it has been common practice to loosen split clamping holders, which fix bearings for the ink ductor roller, and move the ink ductor roller in a lateral direction directly and manually within the lateral clearances of the split clamping holders.

However, the above-mentioned adjusting work for the ink ductor roller has posed the following problems:

(1) During the adjusting work, the machine has to be stopped. During sampling, the machine has to be driven. Such operations repeated several times result in great losses of the adjusting time and test printing sheets.

(2) Since the adjusting work for the ink ductor roller is done manually, fine adjustment is difficult and printing accuracy cannot be increased.

(3) When initially setting the ink ductor roller, it is difficult to know where in the clearances of the split clamping holders the ink ductor roller is located, and it is hard to determine the home position.

(4) In the case of rainbow printing, the shape of the projections and depressions formed on the surface of the ink ductor roller differs according to the printing product. Thus, whenever printing is changed, the ink ductor roller has to be replaced, requiring frequent adjusting work for the ink ductor roller.

The present invention has been proposed in light of the above-described circumstances. The present invention provides an inking device of a printing press which can easily set an ink ductor roller at a home position, and can adjust the position of the ink ductor roller during operation of the machine by moving the ink ductor roller laterally.

### SUMMARY OF THE INVENTION

A first aspect of the present invention is an inking device of a printing press, including an ink ductor roller reciprocating between a receipt position, at which the ink ductor roller contacts an ink fountain roller to receive ink, and a transfer position, at which the ink ductor roller contacts a roller located downstream in an ink transfer direction to pass the ink on to the roller, the inking device comprising: a pair of swing members supporting the ink ductor roller and supported swingably; and moving means for moving the pair of swing members in an axial direction of the ink ductor roller.

According to a second aspect of the present invention, the swing members may be fixedly mounted on a shaft extending between a pair of frames to be rotatable and slidable, and the shaft may be slid by the moving means and rotated by swinging means.

According to a third aspect of the present invention, the moving means may include a sleeve fitted on the shaft to be relatively rotatable and unmovable in an axial direction, and having a thread provided on an outer periphery of the sleeve, a worm wheel fitted to the outer periphery of the sleeve and supported by the frame to be rotatable and unmovable in the axial direction, a worm shaft meshing with the worm wheel, and drive means for rotationally driving the worm shaft.

According to a fourth aspect of the present invention, the worm shaft may be built in the frame.

According to a fifth aspect of the present invention, the moving means may include an engaging portion provided on the shaft, a moving member having an engaged portion in engagement with the engaging portion and supported to be movable in an axial direction of the shaft, and drive means for moving the moving member.

According to a sixth aspect of the present invention, the engaging portion may be a board member attached to the shaft, the engaged portion may be a restraint member provided in the moving member for restraining a relative movement of the moving member in the axial direction of the shaft with respect to the board member, and the drive means may be a thread.

According to a seventh aspect of the present invention, the swinging means may include a cam follower journaled by the shaft via a bracket, and a disk-shaped cam supported on a side of the frame to be rotatable for rolling contact with the cam follower.

According to an eighth aspect of the present invention, the cam follower and the cam may always contact each other in a range of movement of the shaft.

According to a ninth aspect of the present invention, the ink ductor roller may have projections and depressions on a circumferential surface thereof.

According to a tenth aspect of the present invention, the ink ductor roller may be supported between the pair of swing members, with no clearance being provided in the axial direction of the ink ductor roller.

According to an eleventh aspect of the present invention, two of the ink fountain rollers and two of the ink ductor rollers may be provided, and the ink transferred to each ink ductor roller may be transferred to an ink merger roller provided downstream, in the ink transfer direction, of each ink ductor roller.

According to a twelfth aspect of the present invention, the ink transferred to one of the ink ductor rollers may be directly transferred to the ink merger roller, and the ink transferred to the other of the ink ductor rollers may be transferred to the ink merger roller via one or more intermediate rollers.

According to the inking device of the printing press concerned with the present invention, the ink ductor roller is supported between a pair of the swing members with no lateral clearance being provided, and the swing members are moved in the axial direction of the ink ductor roller by the moving means. By so doing, the ink ductor roller can be easily set at the home position, and the ink ductor roller is laterally moved even during operation of the machine to achieve its position adjustment.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a support configuration drawing of an ink ductor roller, showing Embodiment 1 of the present invention;

FIG. 2 is an essential configuration drawing of an inking unit;

FIG. 3 is a side view of a four-color perfecting offset press;

FIG. 4 is an essential configuration drawing of an inking unit, showing Embodiment 2 of the present invention;

FIG. 5 is a configuration drawing of a motor drive portion;

FIG. 6 is an essential configuration drawing of an inking unit, showing Embodiment 3 of the present invention; and

FIG. 7 is an essential configuration drawing of an inking unit, showing Embodiment 4 of the present invention.

### DETAILED DESCRIPTION OF THE INVENTION

An inking device of a printing press according to the present invention will now be described in detail by embodiments with reference to the accompanying drawings.

### Embodiment 1

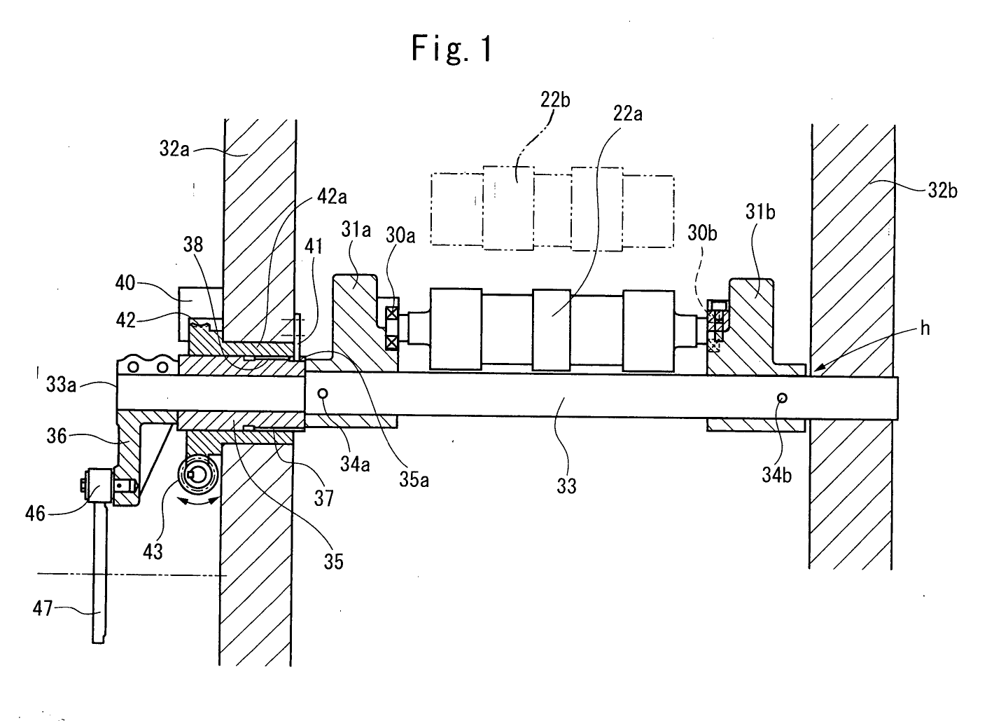

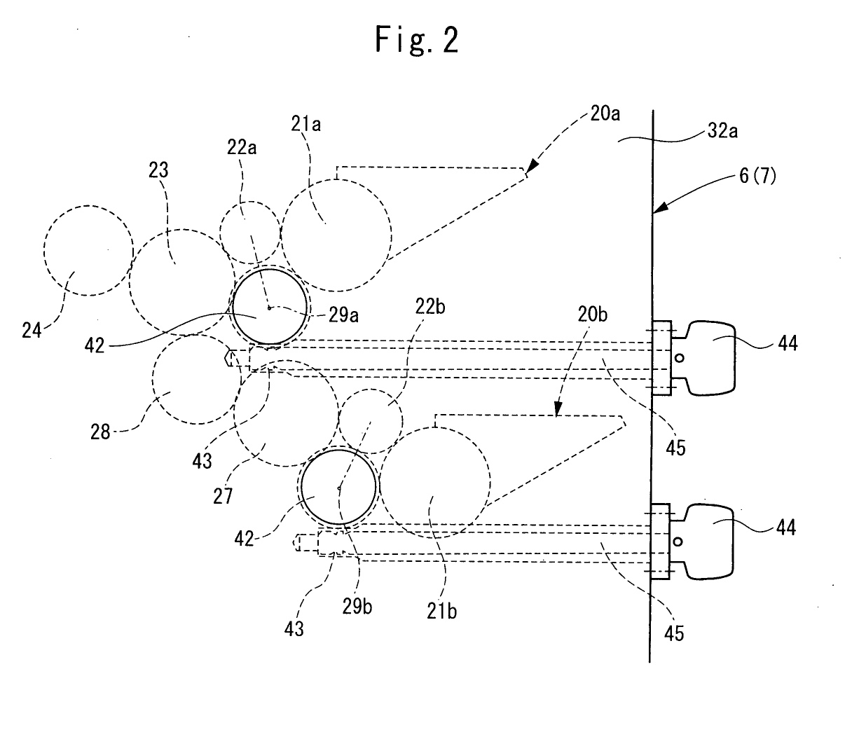

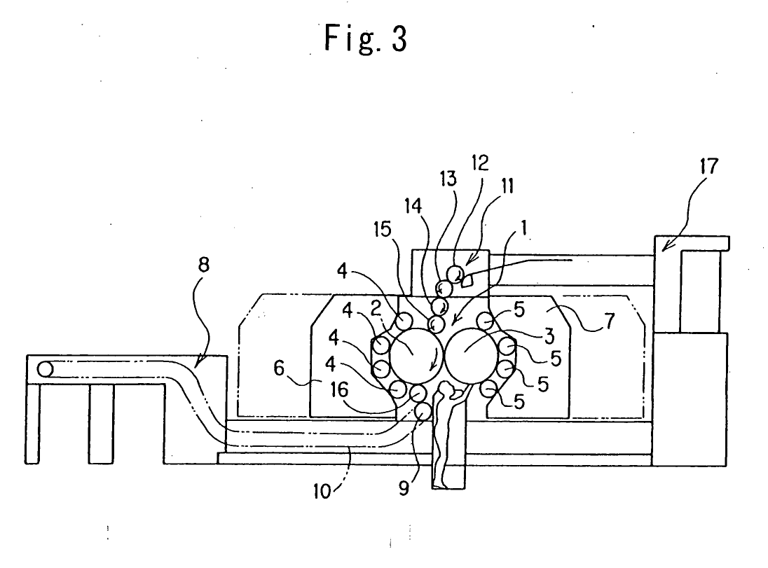

FIG. 1 is a support configuration drawing of an ink ductor roller, showing Embodiment 1 of the present invention. FIG. 2 is an essential configuration drawing of an inking unit. FIG. 3 is a side view of a four-color perfecting offset press.

In a printing unit 1 of the present printing press, as shown in FIG. 3, a blanketed impression cylinder 2 equipped with a sheet gripper device and a blanket cylinder 3 without a sheet gripper device are supported nearly horizontally, and their circumferential surfaces are in contact with each other.

Four plate cylinders 4 are arranged on the circumferential surface of the blanketed impression cylinder 2, and four plate cylinders 5 are arranged on the circumferential surface of the blanket cylinder 3. Inking units 6, 7 are movably provided to be movable toward and away from these plate cylinders 4, 5, and can supply ink and water while contacting the plate cylinders 4, 5.

A delivery cylinder 9 of a delivery unit 8 is disposed below the blanketed impression cylinder 2, and a delivery chain 10 does not cross a space below the position of contact between the circumferential surfaces of the blanketed impression cylinder 2 and the blanket cylinder 3, but is disposed leftwardly of the delivery cylinder 9 in the drawing.

Transfer cylinders 12 to 15, which have sheet gripper devices and transfer a sheet from a register 11 to the blanketed impression cylinder 2, are provided. Similarly, a transfer cylinder 16, which has a sheet gripper device and transfers the sheet from the blanketed impression cylinder 2 to the delivery cylinder 9, is provided. In FIG. 3, reference numeral 17 denotes a feeder.

Thus, the sheet, which has been fed from the feeder 17 and positioned by the register 11, is transported along a path shown by arrows in the drawing, namely, along the circumferential surfaces of the transfer cylinders 12 to 15, the blanketed impression cylinder 2, the transfer cylinder 16, and the delivery cylinder 9 in this order. The sheet thus transported has its opposite surfaces simultaneously printed when passing the point of contact between the blanketed impression cylinder 2 and the blanket cylinder 3 from above toward below.

In the inking units 6, 7, as shown in FIG. 2, two ink fountain rollers and two ink ductor rollers are provided in the vertical direction, i.e., ink fountain rollers 21a, 21b which are provided and rotatably supported in ink fountain devices 20a, 20b, and ink ductor rollers 22a, 22b which are provided rotatably in proximity to the ink fountain rollers 21a, 21b and are supported to be swingable about swing fulcrums 29a, 29b. The surfaces of the ink ductor rollers 22a, 22b are formed with projections and depressions, and inks are flowed only on the projections.

On the part of the upper ink fountain device 20a, ink which the ink ductor roller 22a receives upon contact with the ink fountain roller 21a is directly transferred (passed on) to an ink merger (distribution) roller 23. On the part of the lower ink fountain device 20b, on the other hand, ink which the ink ductor roller 22b receives upon contact with the ink fountain roller 21b is once transferred (passed on) to a first intermediate roller 27 formed from a metal roller, then to a second intermediate roller 28 formed from a rubber roller, and then transferred to the ink merger (distribution) roller 23. From the ink merger (distribution) roller 23, the distributed inks are transferred to an ink form roller via a group of ink rollers such as an ink distribution roller 24 and an ink oscillating roller (not shown).

Thus, when printing, called rainbow printing, is performed with boundaries between respective colors being blurred, inks of different colors are placed in the two ink fountain devices 20a and 20b. By so doing, color mixing in the ink fountains is not likely to occur, the quality of the printing product is improved, and the volumes of inks stored in the ink fountains are increased, resulting in increased productivity.

The ink ductor rollers 22a, 22b, as shown in FIG. 1, are supported between a pair of (i.e., right and left) split clamping holders (swing members) 31a and 31b, with no lateral clearance being provided, via bearings 30a and 30b mounted on the shaft ends of the ink ductor rollers 22a and 22b.

The paired split clamping holders 31a, 31b are fixedly mounted by pins 34a, 34b on a shaft 33 extending between a pair of (i.e., right and left) frames 32a and 32b to be rotatable and slidable.

An end (left end) of the shaft 33 is formed as a small-diameter portion 33a. A sleeve 35 is fitted on the small-diameter portion 33a to be relatively rotatable, and the sleeve 35 is positioned between a stepped portion of the shaft 33 and a bracket 36 which is split-clamped at the shaft end of the small-diameter portion 33a, whereby the sleeve 35 is rendered unmovable in the axial direction.

An external thread 37 is provided in a part of the outer periphery of the sleeve 35. An internal thread 38 screwed to the external thread 37 is provided in an inner peripheral surface of a bearing portion 42a formed integrally with a worm wheel 42. The bearing portion 42a is supported by the frame 32a to be rotatable and axially unmovable. Reference numeral 40 denotes a stopper fixed to the frame 32a for preventing the worm wheel 42 (bearing portion 42a) from slipping off. Reference numeral 41 denotes a key similarly fixed to the frame 32a, and has a front end fitted into a groove 35a of the sleeve 35 for performing whirl-stopping.

A worm shaft 43, which meshes with the worm wheel 42 in contact with the stopper 40 for preventing slip-off, is integrally connected to an operating shaft 45 (see FIG. 2) provided with a dial-equipped handle 44. Thus, the shaft 33, the sleeve 35, the worm wheel 42 (bearing portion 42a), the worm shaft 43, and the operating shaft 45 provided with the dial-equipped handle 44 constitute a moving means for moving the split clamping holders 31a, 31b, as swing members, in the axial direction of the ink ductor rollers 22a, 22b. In FIG. 1, the symbol h denotes a clearance for permitting the axial movement of the split clamping holder 31b (i.e., ink ductor rollers 22a, 22b) on the side of the frame 32b.

A cam follower 46 for rotating the shaft 33 is journaled to the front end of the bracket 36, and a disk-shaped cam 47 which the cam follower 46 makes a rolling contact is supported by the frame 32a to be rotatable in a manner interlocked to the machine. Thus, the shaft 33, the bracket 36, the cam follower 46, and the cam 47 constitute a swinging means for swinging the split clamping holders 31a, 31b as the swing members. The cam follower 46 is formed to be larger in width than the cam 47 in consideration of the axial movement of the shaft 33.

Because of the above-described configuration, the shaft 33 is periodically reversibly rotated via the cam follower 46 and the bracket 36 by the cam 47 rotating in a manner interlocked to the machine. As a result, the split clamping holders 31a, 31b fixedly mounted on the shaft 33 are swung.

Thus, the ink ductor rollers 22a, 22b supported by the split clamping holders 31a, 31b are swung about the swing fulcrums 29a, 29b. Accordingly, on the part of the upper ink fountain device 20a, ink received from the ink fountain roller 21a is directly transferred to the ink merger (distribution) roller 23, whereas on the part of the lower ink fountain device 20b, ink received from the ink fountain roller 21b is once transferred to the first intermediate roller 27, and then to the second intermediate roller 28, and is then transferred to the ink merger (distribution) roller 23.

According to the present embodiment, the ink ductor rollers 22a, 22b are supported between the pair of split clamping holders 31a and 31b, with a lateral clearance being absent. Thus, when the ink ductor rollers 22a, 22b are initially set, they are certainly set at a fixed position (home position) in the lateral direction.

Thus, the lateral alignment of the projections of the upper and lower ink ductor rollers 22a and 22b with each other, or the lateral alignment of the projections of the upper and lower ink ductor rollers 22a and 22b with the plate cylinders (plate surfaces) 4,5 is carried out by turning the operating shaft 45 from the outside of the machine via the dial-equipped handle 44.

That is, upon rotation of the operating shaft 45, the shaft 33 is slid by a rotation transmission mechanism composed of the worm shaft 43 and worm wheel 42 rotating integrally with the operating shaft 45, and by a feed screw mechanism composed of the internal thread 38 of the bearing portion 42a and the external thread 37 of the sleeve 35. In accordance with this slide, the ink ductor rollers 22a, 22b are moved in the lateral direction via the split clamping holders 31a, 31b fixedly mounted on the shaft 33, whereby their position is adjusted.

On this occasion, the ink ductor rollers 22a, 22b are moved by a predetermined amount based on a dial reading, so that their position can be adjusted with high accuracy by a visual check. Moreover, unlike conventional procedure, the ink ductor rollers 22a, 22b are not directly moved, but are operated from the outside of the machine via the shaft 33, etc. Thus, the position of the ink ductor rollers 22a, 22b can be adjusted during operation, without stopping the machine.

### Embodiment 2

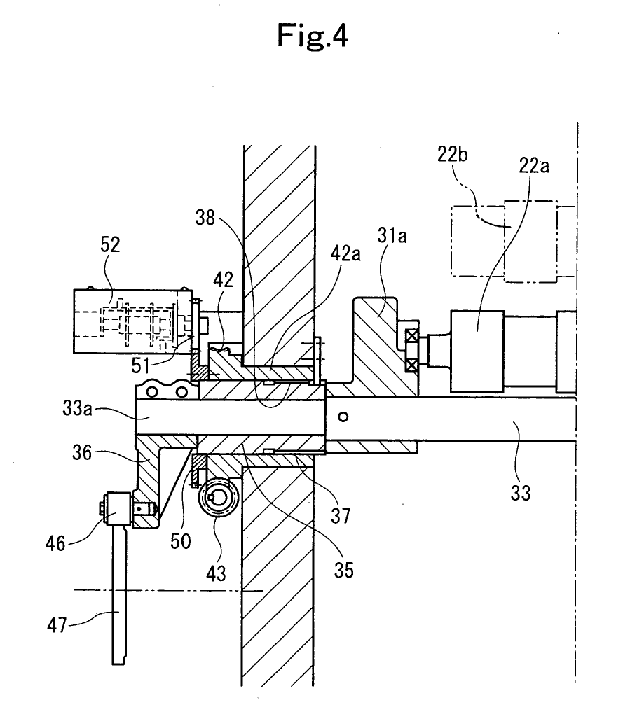

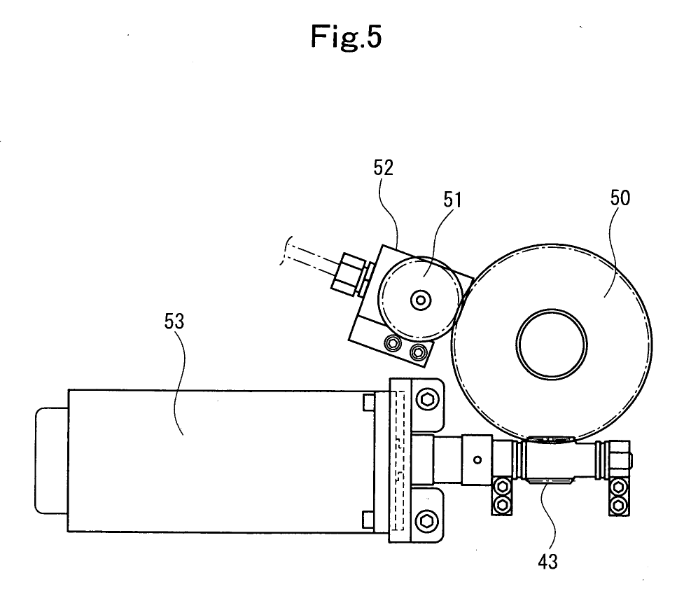

FIG. 4 is an essential configuration drawing of an inking unit, showing Embodiment 2 of the present invention. FIG. 5 is a configuration drawing of a motor drive portion.

This is an embodiment in which the worm shaft 43 in Embodiment 1 is rotationally driven by a motor 53 instead of by the operating shaft 45 having the dial-equipped handle 44, and the amount of rotation of the bearing portion 42a integral with the worm wheel 42 (i.e., the amount of movement of the ink ductor rollers 22a, 22b) is detected by a potentiometer 52 via gears 50, 51. Other features are the same as those in Embodiment 1, and thus duplicate explanations are omitted, with the same members as those in FIG. 1 being assigned the same numerals as those in FIG. 1.

According to the above-described configuration, the advantage that the position adjustment of the ink ductor rollers 22a, 22b can be made automatically and by remote control is obtained, in addition to the same actions and effects as those in Embodiment 1.

### Embodiment 3

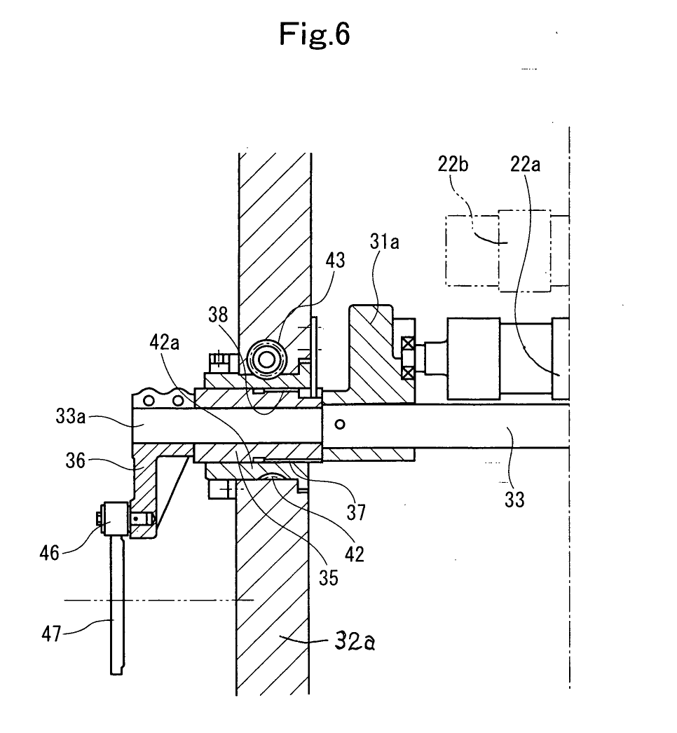

FIG. 6 is an essential configuration drawing of an inking unit, showing Embodiment 3 of the present invention.

This is an embodiment in which the worm shaft 43 in Embodiments 1 and 2 is built in the frame 32a to achieve the compact configuration of the machine. Other features are the same as those in Embodiment 1, and thus duplicate explanations are omitted, with the same members as those in FIGS. 1 and 4 being assigned the same numerals as those in FIGS. 1 and 4.

### Embodiment 4

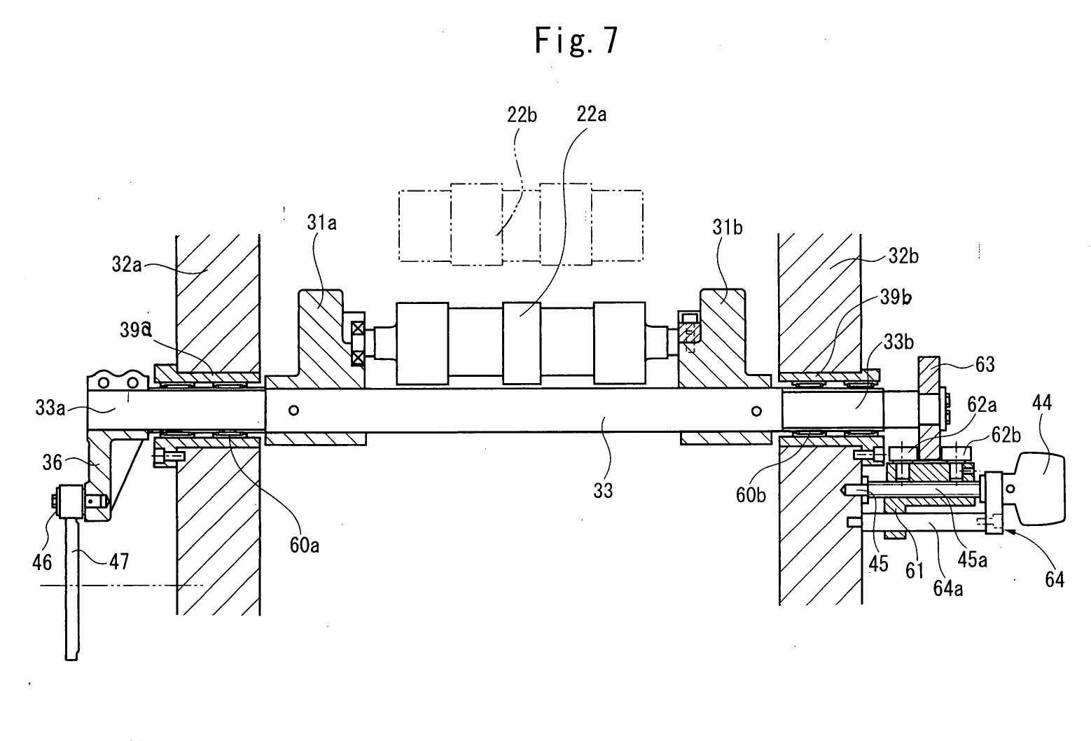

FIG. 7 is an essential configuration drawing of an inking unit, showing Embodiment 4 of the present invention.

This is an embodiment in which opposite end portions of the shaft 33 in Embodiment 1 are formed as small-diameter portions 33a, 33b; the small-diameter portions 33a, 33b are supported by the frames 32a, 32b via needle bearings 60a, 60b and bearings 39a, 39b to be rotatable and movable (slidable) in the axial direction of the needle bearings 60a, 60b; and a disk 63, as an engagement portion and a board member, is attached to the small-diameter portion 33b on the side of the frame 32b of the shaft 33.

An operating shaft 45, as a drive means, having a dial-equipped handle 44 is supported parallel to the shaft 33 and rotatably by the frame 32b via a support member 64, which is assembled in an L-shape and concurrently serves as a guide for a bracket 61 (to be described later) as a moving member. A pair of (i.e., right and left) rollers 62a and 62b, as engaged portions and restraint members, are rotatably planted in the bracket 61 which is screwed to a threaded portion 45a of the operating shaft 45 and slidably fitted on a guide rod portion 64a of the support member 64. The aforementioned disk 63 is located between, and in rolling contact with, the paired right and left rollers 62a and 62b.

Thus, the operating shaft 45 is turned via the dial-equipped handle 44, whereby the bracket 61 is moved laterally by a feed screw mechanism, and the shaft 33 is slid via the disk 63 interposed between the right and left paired rollers 62a and 62b moving integrally with the bracket 61. Other features are the same as those in Embodiment 1, and thus duplicate explanations are omitted, with the same members as those in FIG. 1 being assigned the same numerals as those in FIG. 1.

According to the above-described configuration, in which only the shaft 33 is moved, the advantage that the moving means for the shaft 33 (split clamping holders 31a, 31b) can be simplified is obtained, in addition to the same actions and effects as those in Embodiment 1.

The invention thus described, it will be obvious that the same may be varied in many ways. For example, gears or chain belts may be used instead of the worm shaft 43 and the worm wheel 42 in Embodiments 1 to 3. Alternatively, a grooved pulley may be used to move the shaft 33 axially. In the above respective embodiments, the ink transferred to the upper ink ductor roller is directly transferred to the ink merger roller, while the ink transferred to the lower ink ductor roller is transferred to the ink merger roller via the two intermediate rollers. However, the ink transferred to the lower ink ductor roller may be directly transferred to the ink merger roller, or the ink from the upper ink ductor roller may be transferred to the ink merger roller via one or more intermediate rollers as is the ink from the lower ink ductor roller. The above embodiments disclose examples in which a pair of the ink fountain rollers and a pair of the ink ductor rollers are provided in the vertical direction, but may be provided in the lateral direction. In the respective embodiments, examples of applying the present invention to rainbow printing are disclosed, but the present invention can be applied to a printing press which does not carry out rainbow printing. Such variations are not to be regarded as a departure from the spirit and scope of the invention, and all such modifications as would be obvious to one skilled in the art are intended to be included within the scope of the following claims.

1. An inking device of a printing press, comprising:
an ink ductor roller reciprocating between a receipt position, at which said ink ductor roller contacts an ink fountain roller to receive ink;
a transfer position, at which said ink ductor roller contacts a roller located downstream in an ink transfer direction to pass the ink on to said roller;
a pair of swing members supporting said ink ductor roller and supported swingably; and
moving means for moving said pair of swing members in an axial direction of said ink ductor roller.

2. The inking device of a printing press according to claim 1, wherein said swing members are fixedly mounted on a shaft extending between a pair of frames to be rotatable and slidable, and said shaft is slid by said moving means and rotated by swinging means.

3. The inking device of a printing press according to claim 2, wherein said moving means includes, a sleeve fitted on said shaft to be relatively rotatable and unmovable in an axial direction and having a thread provided on an outer periphery of said sleeve, a worm wheel fitted to the outer periphery of said sleeve and supported by said frame to be rotatable and unmovable in the axial direction, a worm shaft meshing with said worm wheel, and drive means for rotationally driving said worm shaft.

4. The inking device of a printing press according to claim 3, wherein said worm shaft is built in said frame.

5. The inking device of a printing press according to claim 2, wherein said moving means includes an engaging portion provided on said shaft, a moving member having an engaged portion in engagement with said engaging portion and supported to be movable in an axial direction of said shaft, and drive means for moving said moving member.

6. The inking device of a printing press according to claim 5, wherein said engaging portion is a board member attached to said shaft, said engaged portion is a restraint member provided in said moving member for restraining a relative movement of said moving member in the axial direction of said shaft with respect to said board member, and said drive means is a thread.

7. The inking device of a printing press according to claim 2, wherein said swinging means includes a cam follower journaled by said shaft via a bracket, and a disk-shaped cam supported on a side of said frame to be rotatable for rolling contact with said cam follower.

8. The inking device of a printing press according to claim 7, wherein said cam follower and said cam always contact each other in a range of movement of said shaft.

9. The inking device of a printing press according to claim 1, wherein said ink ductor roller has projections and depressions on a circumferential surface thereof.

10. The inking device of a printing press according to claim 1, wherein said ink ductor roller is supported between said pair of swing members, with no clearance being provided in the axial direction of said ink ductor roller.

11. The inking device of a printing press according to claim 1, wherein two of said ink fountain rollers and two of said ink ductor rollers are provided, and the ink transferred to each said ink ductor roller is transferred to an ink merger roller provided downstream, in the ink transfer direction, of each said ink ductor roller.

12. The inking device of a printing press according to claim 11, wherein the ink transferred to one of said ink ductor rollers is directly transferred to said ink merger roller, and the ink transferred to other of said ink ductor rollers is transferred to said ink merger roller via one or more intermediate rollers.
